(19) United States
(12) Patent Application Publication
(10) Pub. No.: US 2008/0164283 A1
(43) Pub. Date: Jul. 10, 2008

(54) Napkin ring and salt and pepper dispenser

(76) Inventor: Oron Markus, Tel Aviv (IL)

Correspondence Address: ORON MARKUS, P.O.Box 29746, Tel Aviv, 61297, omitted

(21) Appl. No.: 12/003,867

(22) Filed: Jan. 3, 2008

Related U.S. Application Data
(60) Provisional application No. 60/884,073, filed on Jan. 9, 2007.

(51) Int. Cl. A47G 19/00; A45F 5/04; B67D 1/07

(52) U.S. Cl. 222/142.1; 24/7; 222/192

(57) ABSTRACT

A ring designed to serve as a diner's personal napkin holder that serves also as the diner's personal salt and pepper dispenser. The ring is hollow and has two closed compartments intended to contain salt and pepper. Holes on the side of the ring enable to dispense the salt and the pepper during use.

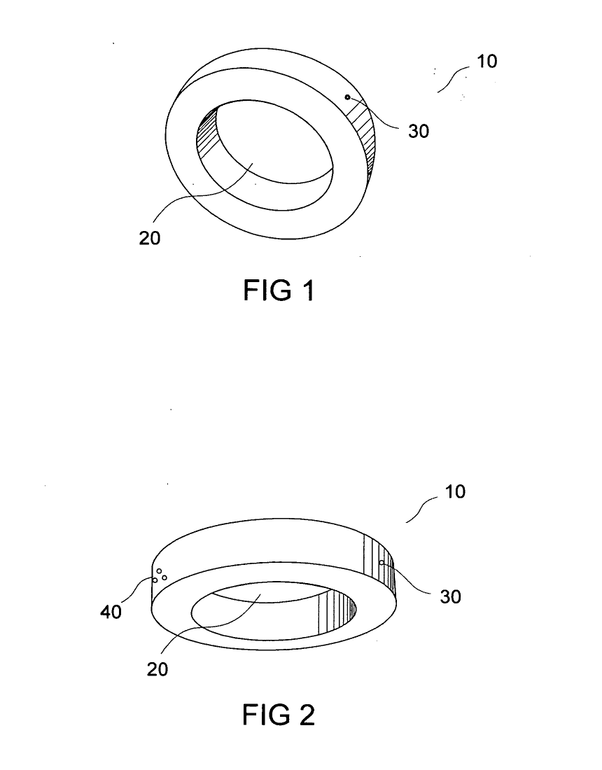

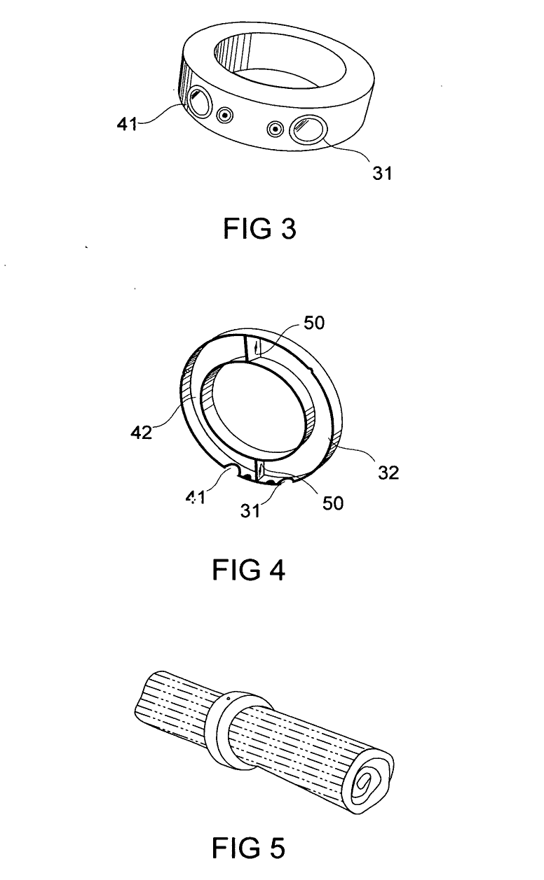

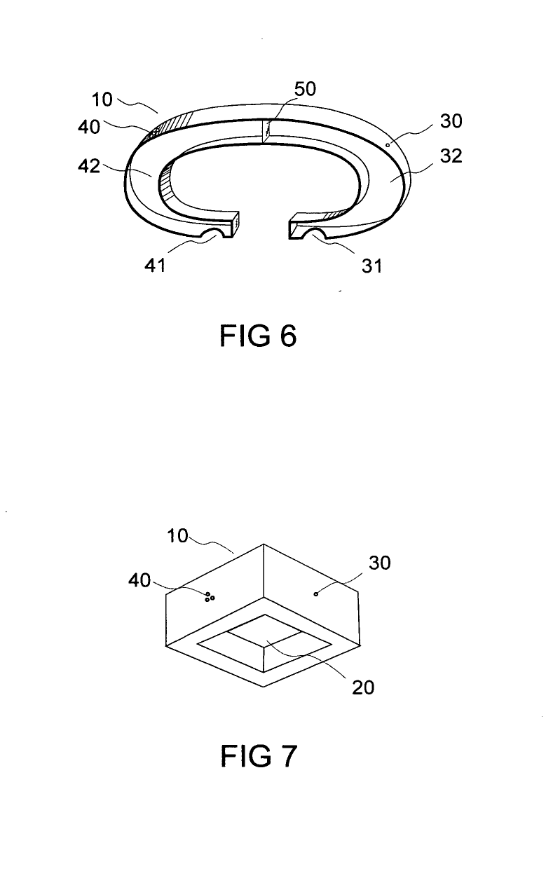

### CROSS REFERENCE TO RELATED APPLICATIONS

Priority is claimed based on U.S. Provisional Patent Application 60884073, filed on 9 Jan. 2007.

### TECHNICAL FIELD

The present invention refers to a ring that constitutes a tableware utensil and serves both as a decorative personal napkin holder that is placed on the dinner table and as the diner's personal salt and pepper dispenser.

### BACKGROUND ART

At many festive occasions, including family events, that include a festive meal, it is customary to decorate the dinner table in an attractive and pleasant manner. In most cases, the table arrangement includes laying out individual napkins for each of the diners. In some cases, a decorative accessory, designed to hold the napkin, is used both in order to add an exclusive stylish touch to the table arrangement and to prevent the napkin from blowing away (in the case of an outdoors event) or to keep it in its designated place on the table (in front of the diner). In addition, it is customary to place a saltshaker containing salt and a peppershaker containing pepper on the table.

### THE INVENTION

### The Numbers in Parentheses Refer to the Corresponding Numbers in the Drawings

The present invention refers to an accessory that serves both as a personal napkin holder on the dinner table and as the diner's personal salt and pepper dispenser. The accessory, subject of the invention, includes a means for holding the napkin. The means for holding the napkin can be a hole in the accessory through which the napkin is inserted or a clip, a clasp, a pin or any other known device that can hold a personal napkin. The accessory also includes one or more internal compartments that contain the condiments, salt and pepper.

The accessory, subject of the invention, can also be implemented with only one internal compartment that will contain only salt or any other condiment.

The accessory, subject of the invention, includes a hole through which the internal compartment can be filled with salt or any other condiment. The accessory also includes one or more holes through which the salt can be dispensed from the internal compartment onto the food, as with any other standard saltshaker.

The drawings attached to the application describe one of many possible ways of implementing the invention. One option for implementing the invention refers to a ring-shaped accessory (10) with a hole (20) in the middle. The outer side of the ring (10) has a hole (30) through which the salt can be dispensed and another hole or holes (40) through which the pepper (or any other condiment in the relevant internal compartment) can be dispensed, as depicted, for instance, in Drawings Nos. 1 and 2.

The ring (10) is hollow, i.e. it has one or more internal compartments designed to contain salt, pepper or any other condiment as per the users' choice. The ring (10) described in the drawings has two separate internal compartments that are intended to contain salt and pepper. As depicted in Drawing No. 3, the side of the ring (10) has a hole (31) through which salt is introduced into the internal compartment of the ring (10). There is also another hole (41) through which pepper is introduced into the internal compartment of the ring (10).

As mentioned, the ring (10) has two hollow compartments, one for salt and the other for pepper. Drawing No. 4 refers to an accessory, subject of the invention, that is a ring (10) and that has, as mentioned, two internal compartments. One option of creating two compartments within the accessory, subject of the invention, or within the ring (10) is depicted in Drawing No. 4. Drawing No. 4 depicts the internal structure of the ring (10), which includes an internal cavity that is divided into two separate compartments. One compartment (32) is intended to contain salt and the other compartment (42) is intended to contain pepper. As mentioned, the internal cavity within the ring (10) is separated by two partitions (50) into two compartments (32 and 42). The side of the ring (10), which serves also a cover that closes the ring, as depicted in Drawings No. 1, 2, and 3, is not depicted in Drawing No. 4.

Drawing No. 5 depicts the ring (10) in used, with a diner's personal napkin inserted into it.

The accessory, subject of the invention, in general and the ring (10) depicted in the drawings in particular can be implemented in various dimensions and sizes and from a variety of materials. One optional implementation of the ring (10), although not the only implementation, is with a diameter of about 5 cm. and a hole in the middle with a diameter of about 3 cm. This optional implementation of the ring (10), although not the only implementation, is made of materials such as metal or plastic.

Another possible implementation of the invention refers to an partially open ring, as depicted, for instance, in Drawing No. 6.

In this case, one internal partition (50) will suffice in order to create two separate compartments for salt and pepper. For aesthetic reasons, it is recommended to implement the invention using materials and shapes of desirable designs and colors.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

### DESCRIPTION OF THE DRAWINGS

The drawings attached to the application are not intended to limit the scope of the invention and the possible ways of its application. The drawings are intended only to illustrate the invention and constitute only one of many possible ways of its application. The drawings are described at detail in the body of the above application.

What is claimed is:

1. An accessory designed to hold a diner's personal napkin that serves also as a saltshaker.

2. The accessory mentioned in claim No. 1, including one or more internal compartments intended to contain salt or other condiments.

3. The accessory mentioned in claim No. 1, designed as a closed ring that has two separate internal containers intended to contain salt or condiments, whereby the side of the said ring has holes designed to enable to dispense the salt or condiments during use.

4. The accessory mentioned in claim No. 1, designed as a partially open ring, with two separate internal containers intended to contain salt or condiments, whereby the side of the said ring has holes designed to enable to dispense the salt or condiments during use.

5. The accessory mentioned in claim No. 4, designed as a partially open ring that has two separate containers intended to contain salt or condiments, whereby the side of the said ring has holes designed to enable to dispense the salt or condiments during use.
